(19) United States
(12) Patent Application Publication
(10) Pub. No.: US 2005/0169015 A1
(43) Pub. Date: Aug. 4, 2005

(54) LED color changing luminaire and track light system

(76) Inventors: John F. Luk, Flushing, NY (US); Dean J. Reiter, Stony Point, NY (US); John T. Ryan, Riverdale, NY (US); Thomas P. Tyler, Wallkill, NY (US)

Correspondence Address: Lackenbach Siegel LLP, One Chase Rd., Scarsdale, NY, 10583, US

(21) Appl. No.: 10/945,743

(22) Filed: Sep. 20, 2004

Related U.S. Application Data
(60) Provisional application No. 60/503,843, filed on Sep. 18, 2003.

(51) Int. Cl. F21K 2/00

(52) U.S. Cl. 362/648

(57) ABSTRACT

A LED luminaire track lighting system includes an elongate track, having a number of longitudinal guideways, for attachment to a support surface, as well as a number of current conductors arranged within at least some of the guideways. The first of these conductors are power conductors and the second conductors are data conductors, the conductors being electrically isolated from each other. The lighting system further contains a first adapter for connection to a source of electrical power for the power conductors, and a second adapter for connection to a source of control data for application of data to the data conductors. There is at least one LED color-changing luminaire present in the system, and this luminaire contains a number of LEDs, each of which, when energized, generates a single color out of a discrete plurality of colors. A data converter converts data along the data lines to control the currents in the individual groups of color LEDs so that they create a desired composite color. Further, at least electrically, the LED color-changing luminaire is at least electrically connected to the power conductors and data conductors in the track.

### CROSS-REFERENCE TO PRIOR APPLICATIONS

This utility patent application is based on U.S. Provisional Patent Application No. 60/503,843 filed Sep. 18, 2003.

### BACKGROUND OF THE INVENTION

1. Field of the Invention

This invention relates to power and data track-lighting systems and particularly to LED color-changing luminaires for use in power and data track-lighting systems in conjunction with conventional track-mounted high-voltage lamps and luminaires.

2. Description of the Prior Art

Track-lighting systems have been around for many years. Some manufacturers of track lighting include Halo, Juno, Lightolier, and Nordic Aluminium, who manufacture lighting tracks and fittings mounted to luminaires for use in their lighting tracks. Lighting tracks are available for use with high AC voltages as well as low DC voltage systems. For safety reasons, and to adhere to the National Electrical Code (NEC) and the UL1574 Standard for Track Lighting Systems, these cannot be mixed together unless they are specifically marked for the different operating voltages. In the alternative, they can be required to have a positive means to prevent the luminaires designed with high-voltage or line-voltage lighting tracks from mixing with luminaires designed for use with low-voltage lighting tracks and vice versa. This NEC safety requirement creates problems for some end users who would like to combine low-voltage and high-voltage track luminaires at the same location, and within close proximity to each other, without presenting any possible safety issues during installation.

The IQ architectural series of luminaires and particularly the IQ Spectra Series LED color-changing luminaires designed and manufactured by Altman Lighting, Inc., based in Yonkers, N.Y., requires that the LED color-changing track-mounted luminaires be used with conventional track-mounted luminaires utilizing high-voltage incandescent, halogen, compact fluorescent, HID, and UV type lamps, all operating on the same line voltage lighting track. In addition, control data has to be supplied to the new LED color-changing luminaires or other DMX controllable devices used along with the track-mounted luminaires without the need to run additional control cable to the individual track-mounted luminaires.

### SUMMARY OF THE INVENTION

In the preferred embodiment of the present invention, LEDs in different colors are mounted on a circuit board that is then affixed to a heat sink. The complete LED, circuit board, and heat sink assembly is then installed inside a vented PAR lamp housing. An internal compact power and data adapter and 24VDC power supply is also installed within the same PAR lamp housing juxtaposed to the LED, circuit board, and heat sink assembly. The data input portion of the compact power and data adapter is sent out via discrete wires and terminates in a DMX track mount fitting or a similar control data connector. The AC power input portion of the 24VDC power supply is fed by discrete wires leading into a track adaptor fitting. The 24VDC power output from the internal power supply is tied directly to the power input connector of the compact power and data adapter. Likewise, the power and data for the LED circuit board is also tied directly to the power and data output connector of the compact power and data adapter.

An LED color-changing luminaire in accordance with the present invention for use in a DMX track lighting system is a substantial improvement over existing systems, as will be appreciated by those skilled in the art from the following summary and the detailed description of the invention.

It becomes evident that the present invention and system provides various benefits and advantages.

An object of the present invention is to provide a track-mounted LED color-changing luminaire for use on a special track lighting fitting that can be operated from a remote serial data communications controller.

Another object of the present invention is to provide an LED color-changing luminaire that can be easily manufactured from readily available and off-the-shelf components.

It is a further object of the present invention to provide a family of fixtures centered around the Altman Lighting IQ series luminaires that include the LED color-changing Spectra Series luminaires, halogen lamp luminaires, compact fluorescent, and HID lamp luminaries, including UV black light luminaires. All luminaires in this family can operate simultaneously on the same track lighting system producing different light outputs, color temperatures, and overall looks.

It is yet another object of the present invention to provide luminaires that can all operate on a single type of line voltage track lighting fitting without the need to install low-voltage and line-voltage lighting track.

The Altman IQ series of aesthetic luminaires are designed and manufactured exclusively for architectural applications using primarily the PAR type medium screw base lamps including the PAR20, PAR30, PAR38, PAR46, PAR56, and PAR64 sealed PAR type lamps. It should be noted that other lamps and housings can be used as well in this system.

It will be appreciated by one skilled in the art that other similar components can be used in part or in its entirety for the design of the LED color changing luminaire including its shape and size, and the subsequent track lighting system, without departing from the basic functions or results of the original invention and system. Those skilled in the art will also appreciate the improvements and advantages that derive from the present invention upon reading the following detailed description, claims, and drawings.

### BRIEF DESCRIPTION OF THE DRAWINGS

FIG. 1 Side View of an LED luminaire assembly of the type in accordance of the present invention for use with a track;

FIG. 2 is an exploded view of the LED luminaire illustrated in FIG. 1;

FIG. 3 is a side elevational view of a heat sink that can be used with the LED circuit board illustrated in FIG. 2;

FIG. 4 is a bottom view of the heat sink shown in FIG. 3;

FIG. 5 is a schematic diagram of a compact power and data adaptor (CPDA) printed circuit board for transmitting signals from a multi-conductor track to the LED circuit board shown in FIG. 1 and FIG. 2;

FIG. 6 is a schematic diagram of an LED printed circuit board used in the assembly shown in FIG. 2;

FIG. 7 is a side elevational view of a plurality of luminaires mounted on a track lighting system in accordance with the invention, in which at least one of the luminaires is an LED luminaire, and the others may comprise luminaires such as quartz HID, fluorescent and the like;

FIG. 8 is a cross-sectional view of a typical track that may be used in connection with the present invention;

FIG. 9 is similar to FIG. 7, except that the luminaire fixture bodies are physically supported by means of hooks mounted on tubes or pipes and are electrically connected to the track by means of a short length of conductors or pigtails; and

FIG. 10 is a schematic diagram of a prior art arrangement in which the individual luminaires are connected to the power and data boards by means of generally long individual conductors.

### DESCRIPTION OF THE PREFERRED EMBODIMENTS

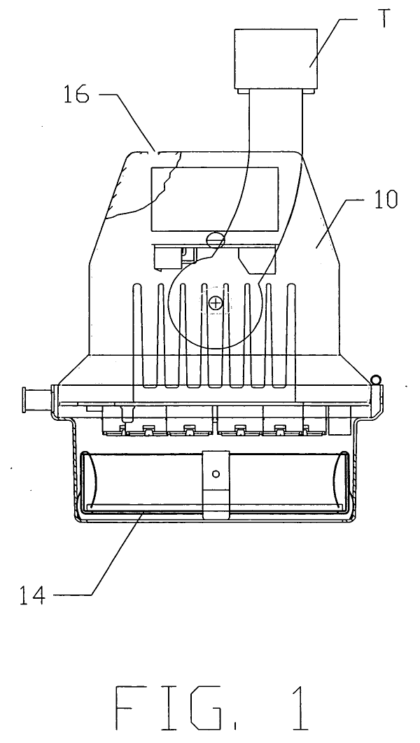

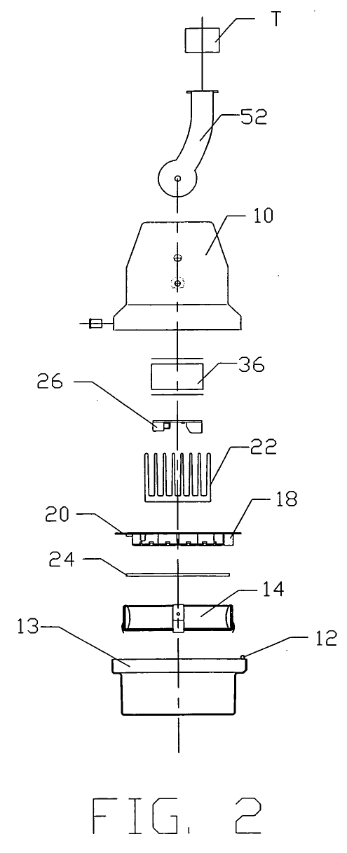

Referring to the figures, and FIGS. 1 and 2 in particular, and using numbers and letters to refer to identical or similar parts thereof, an IQ series PAR housing 19 is made of spun metal and hinged, at 12, to a spun-metal front cover and internal accessory holder 14. The rear of the IQ series PAR housing is provided with slot openings 16 for proper ventilation and cooling of the luminaire. The front accessory holder 14 is designed in such a way as to accept optional accessories including barn doors, snoots, sparkle hoods, baffles, diffusion lenses, etc. The IQ family of fixtures is available with a variety of lamp sources including LED, incandescent, halogen, compact fluorescent, HID, and ultra-violet (UV).

One LED circuit board used in the Altman IQ Spectra Series luminaire, and particularly in the IQ38 series, is a complete LED circuit board assembly 18 available from Color Kinetics using the same light source used in their Color Burst 6 (PN: DLE C-101) LED color-changing fixtures. The LED circuit board 18 contains eighteen one-watt Luxeons available from Lumileds Lighting, Inc. There are six red-, six green-, and six blue-colored Luxeons LEDs. The LED circuit board is rated at 18-watts total and functions with just three inputs. The three inputs are power, ground, and data and are designated as J3, J2, and J1, respectively. The power is 24VDC, ground is known as COM, and data is a single wire conductor used to address and control the intensities of each colored Luxeon LED.

For alternate portable applications, the power, ground, and data terminals will be brought out to a XLR type connector or similar data connector. An additional pin can be used to connect the luminaire housing to earth ground, but is not required for UL or NEC for low-voltage applications. For a four-pin XLR type connector, pin 1 will be 24VDC power using 14 AWG wire, pin 2 will be earth ground using 22 AWG wire, pin 3 will-be data using 22 AWG, and pin 4 will be the common ground or COM for the 24VDC and data line using 14 AWG wire. For a three-pin XLR type connector, pin 1 will be the common ground or COM for the 24VDC and data line, pin 2 will be the 24VDC power, and pin 3 will be the data line. The XLR connectors are available from Neutrik USA, Inc., located in Lakewood, N.J., or an equivalent manufacturer, and the four-conductor cable will be the standard Proplex PCCCT cable available from TMB Inc. in Englewood, N.J., or an equivalent cable supplier meeting the same conductor size requirements, ratings, and safety certifications. In certain instances, as with permanent installations, no connector is supplied with the luminaire. Instead, the luminaires are supplied with wire pigtails that are hard-wired directly to the input power and control data source.

The circuit board 18 is a metal clad substrate to which the eighteen-color Luxeon LEDs are soldered on one side. The opposite smooth aluminum side 20 of the metal clad substrate circuit board is then affixed to a heat sink adequately designed to dissipate the heat generated by the eighteen-color Luxeon LEDs. Thermal transfer silicone adhesive type TP190, or Sil-Pads available from Chomerics NA in Woburn, Mass., can be used to affix the circuit board to the heat sink. Other methods of attachment will be evident to those skilled in the art. These include mechanical fasteners such as screws, bolts, and clips.

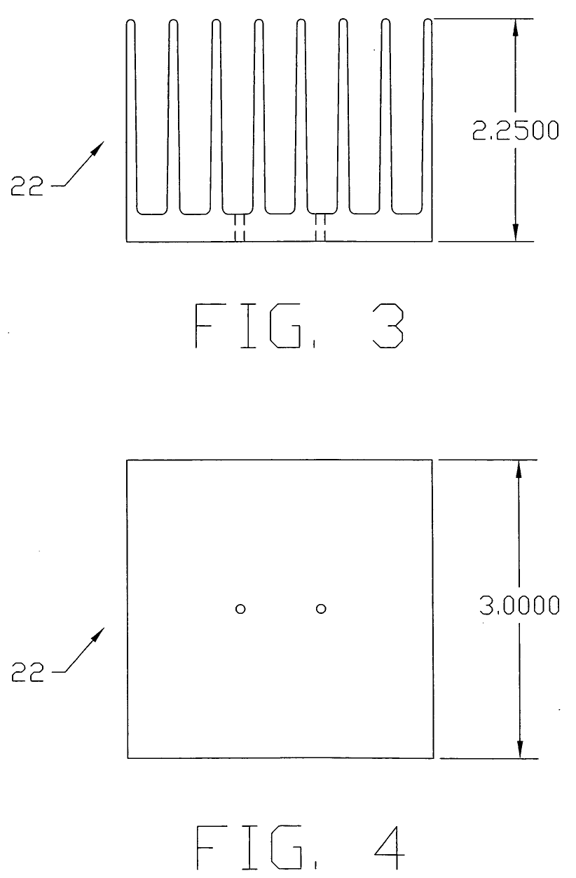

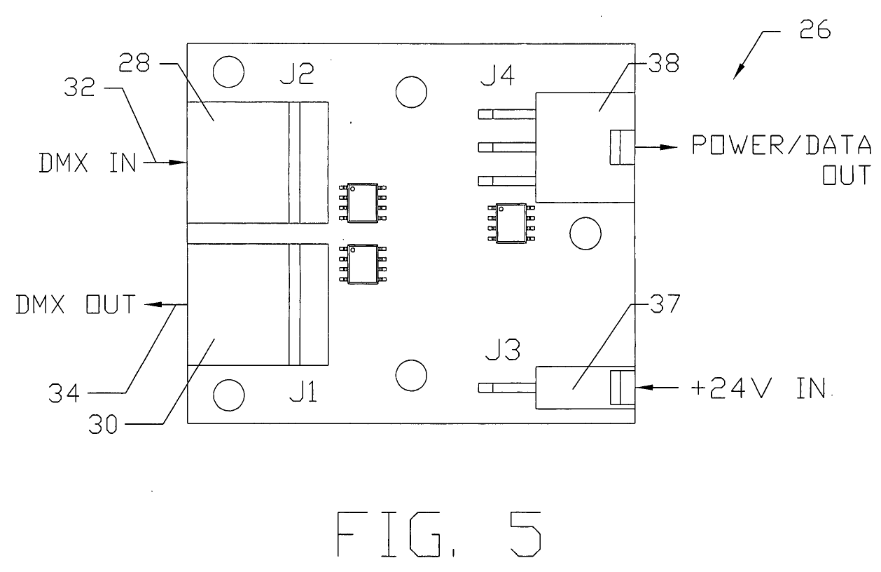

Referring to FIGS. 3 and 4, the heat sink 22 will be one cut from a length of aluminum extrusion. It is available from Aavid Thermalloy Part Number 637303B03000 (VIS# 039016). The heat sink is black anodized and has a thermal resistance of 1.8° C. per watt. The height of the heat sink is 2.25 in., and the outer dimensions are roughly 3.00 in.×3.00 in. A thermal rule of thumb for heat sink design is to have the heat dissipation surface area at approximately 6 sq. in. for each LED. Since eighteen Luxeon LEDs are used, at least 108 sq. in. of surface area will be needed for adequate cooling of the eighteen Luxeon LEDs. Calculating the extrusion profile gives us approximately 108 sq. in. of surface area available in this heat sink part. Therefore this heat sink is ideally matched for the LED circuit board used in the IQ38 Spectra Series luminaire. The use of a supplemental cooling fan is optional.

The LED circuit board 18 and heat sink assembly 22 will be mounted into the front portion of the rear PAR38 spun-metal housing 10 and will be held in place by a circular tension spring clip or other securing bracket means (not shown). Although the IQ38 Spectra Series luminaire will have no serviceable parts, the LED circuit board 18 and heat sink assembly 22 can be installed and removed easily from the front portion of the rear PAR38 spun-metal housing 10.

A front 4.75-in.-diameter diffusion lens 24, installed in the internal accessory holder, is used to better mix the color beam outputs from each red, green, and blue Luxeon LED. The lens is of ⅛-in.-thick plastic lens and has a diffused surface on one side of the flat lens and a smooth surface on the opposite side of the flat lens. It is available from Lee Filters USA in Burbank, Calif., or AIN Plastics PN: P95, and has a transmission rating of 90% or higher.

The next electrical component in this intelligent LED color-changing luminaire will be a compact power and data adapter (CPDA) 26, shown schematically in FIG. 5. The adapter includes a board PN:20-009952 available from James Industries and manufactured exclusively for Color Kinetics of Boston, Mass. The CPDA board 26 is a double-sided board with approximate dimensions 2.265 in.×1.875 in. There are two Ethernet type RJ45 connectors 28, 30, designated as J1 and J2, which are the inputs and outputs for a DMX control signal. On the RJ45 connectors, pin 1 is DATA−, pin 2 is DATA+, and pin 3 is GROUND for the DMX control signal. The DMX input control signal going into connectors J1 and J2 are subsequently converted within the CPDA board into a single proprietary data control line designated as pin 6 on connector J4. This proprietary data control signal delivers CHROMACORE to the LEDs to change color intensities.

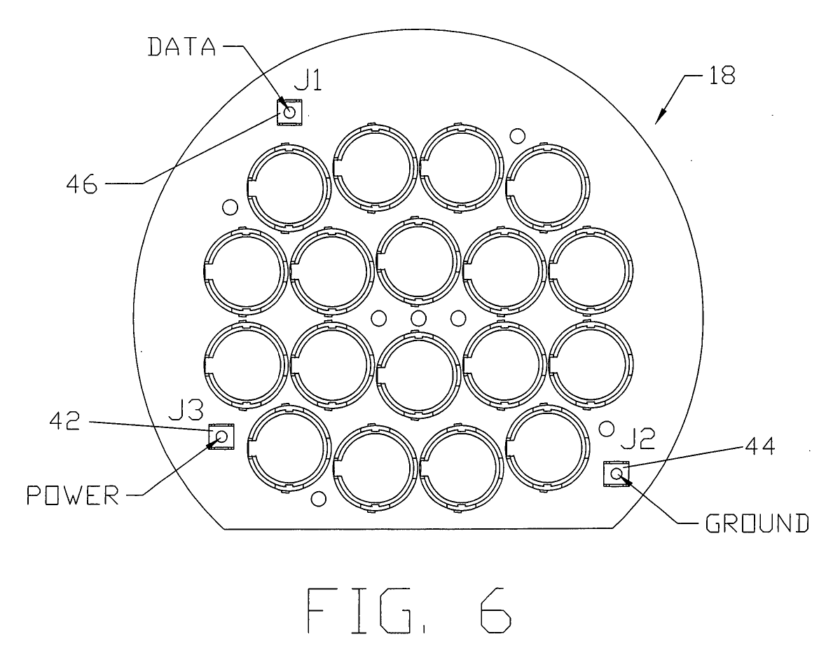

There is a two-position Molex/Waldom Mini-fit Jr. connector designated as J3 for power input into the CPDA board. Pin 1 of J3 is 24VDC and pin 2 of J3 is ground or COM. A final six-position Molex/Waldom Mini-fit Jr. connector, designated as J4, is used as the power, ground, and data line output to the LED circuit board 20 (FIG. 6). Pin 1 is ground or COM out, pin 2 is 24VDC power out, and pin 6 is the data line out to the LED circuit board. Pins 3, 4, and 5 of connector J4 have no designated connections and are not used. The RJ45 and Molex/Waldom Mini-Fit Jr. connectors can be replaced with other types of interface connectors, i.e., screw terminal connectors, to ease wiring.

Although the CPDA board accepts DMX input control signals and is the preferred control signal in the present invention, other serial data communication protocols can be used in the present invention with conversion hardware to control the intensities of the LEDs. Such serial data communication protocols include, but are not limited to: DMX-512, Ethernet, Strand AMX, RS232, RS485, and DALI (Digital Addressable Lighting Interface), among many others.

It should be noted that one skilled in the art can substitute other current control techniques and methods to change the intensities of the color LEDs. However, it is obvious that this substitution would result in a product that is similar if not identical to that disclosed in the preferred embodiment of the track-lighting control system of the present invention, even if the specific details of the control techniques and methods were different. In addition, in place of color LEDs used in the IQ38 Spectra Series luminaires, monochrome LEDs can be used as the main source of light in the track-mounted LED luminaires of the present invention.

The power supply 36 going into the CPDA board is the Optotronic 24VDC LED power supply PN: 51512 available from Osram Sylvania. The Optotronic 51512 LED power supply is a UL and CSA recognized electronic component with Class 2 outputs. It is rated at 20-watts with a nominal universal input voltage range of 120-240 volts AC. The Optotronic 51512 LED power supply has an isolated output so it is protected against open circuits, short circuits, overloads, and overheating. It measures approximately 2.36 in.×2.36 in.×1.20 in. and is protected in a low-profile, weather-resistant plastic housing. The normal operating temperature rating for this power supply is from 20° C. up to 50° C., with a maximum temperature rating of 75° C. This power supply is available from Gilway Technical Lamp Company located in Woburn, Mass. Gilway Technical Lamp Company is the exclusive distributor for Osram Sylvania. It should be noted that one skilled in the art could use any +24VDC LED power supply.

The CPDA board 26 and the LED power supply 26 mentioned above are also installed inside the IQ PAR38 housing. Standoffs and base plates may hold the CPDA board and LED power supply securely together deep inside the rear portion area of the IQ PAR38 spun-metal housing 10 close to the ventilation slots 16.

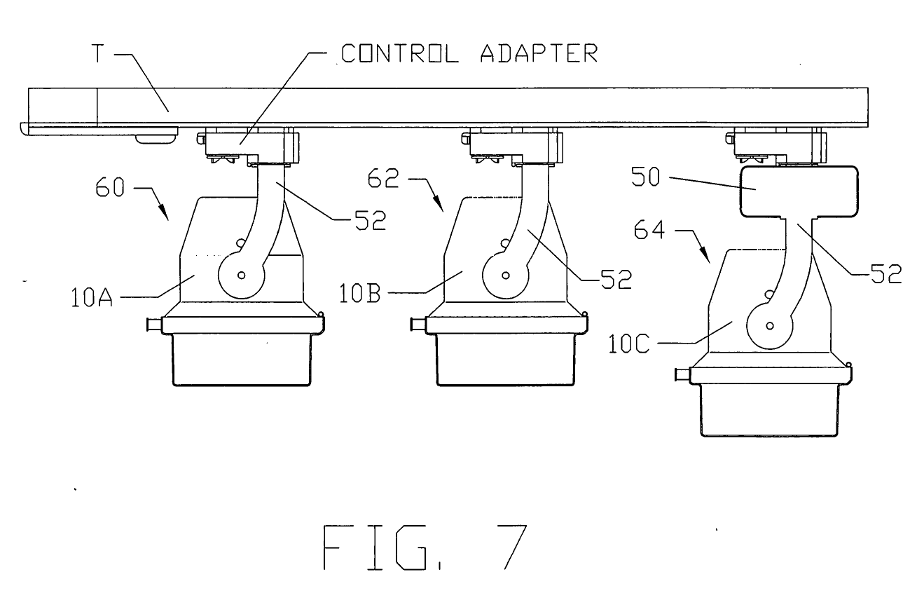

Referring to FIG. 7, for alternate portable luminaire applications, the CPDA board 26 and the LED power supply 36 can be removed from the luminaire housing, such as the housing 10C, and these components are then placed into an auxiliary housing 50. The auxiliary housing 50 may be secured to the yoke 52 or secured in any other known way even to the housing 10 itself. However, because of heat transfer issues, the major and auxiliary housing are connected with a thermal break or barrier to minimize heat transfer therebetween.

In a further embodiment, the power, ground, and data lines to the LED circuit board are brought in from an external source by way of an extension cable. This LED circuit board extension cable may consist of a six-foot 18/3 SVT type or equivalent cord fitted with a mating Molex/Waldom Mini-Fit Jr. six-position vertical dual connector PN: 39-01-2061 fitted with male terminals PN: 44478-3112. This connector may mate with the female Molex/Waldom Mini-Fit Jr. connector attached to other end of the IQ38 LED circuit board to CPDA cable and attached directly to the LED circuit board by way of input pins J1, J2, and J3. The opposite end of the LED circuit board extension cable is terminated with a Phoenix contact MSTB 2.5/3-ST-5.08 three-position screw terminal plug. This plug can be used directly with a Color Kinetics Power and Data Supply, i.e., PDS-150e, which allows a user to connect up to six IQ38 luminaires at the same time. The PDS150e provides the 24VDC, ground, and data necessary to control the intensities of each Luxeon LED located in the LED circuit board.

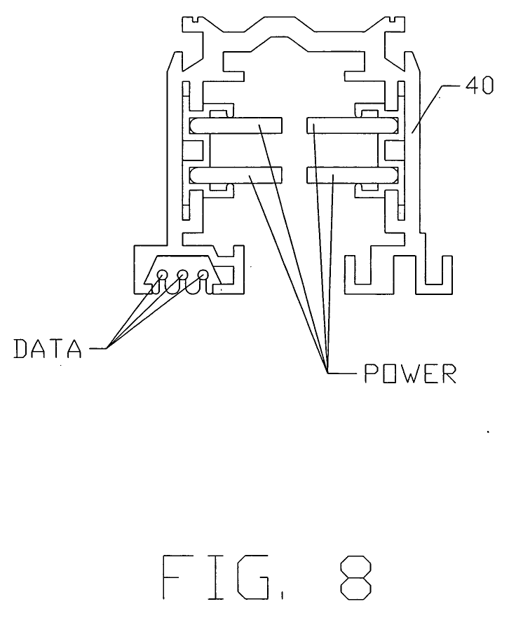

In accordance with a feature of the invention, the light fixtures are at least electrically connected to a track system of the type disclosed in U.S. Pat. No. 5,869,786. In FIG. 8, a cross-section of an extrusion 40 is illustrated. This extrusion is a modification of the extrusion shown in the '786 patent.

The track-lighting fittings and track adapters used in the preferred embodiment of the present invention are the GLOBAL control SELV-data track system available from Nordic Aluminium represented in North America by Kaltek, Inc., located in Atlanta, Ga. These are illustrated in its lighting fixture control publication No. 06-2001/2.000, a copy of which is submitted and incorporated herewith. The lighting track fittings include one, two, and three circuit tracks designated by their GC7 series part numbers and their multi-adapter track adapters are available in two and three circuit versions designated by their GC68 series part numbers. A GLOBAL control module designated by part number GCM-DMX is required to bring the DMX control signals from a DMX controller directly to the track-lighting fittings. In the near future, GLOBAL plans to introduce a modified power and control data track that will take advantage of both DMX and DALI control data protocols.

Internal wiring of the electronic components of the IQ38 Spectra Series luminaires will consist of the following detailed pin-to-pin descriptions. The LED circuit board 20 contains three terminal tabs 42, 44, 46 that accept modular 3/16 in. spade lugs. The three tabs include power, ground, and data connections. These three terminals designated as J3, J2, and J1 are tied into the CPDA board to connector J4. The mating plug to connector J4 is a Molex/Waldom six-position dual row Mini-fit Jr. connector. Terminal J3 on the LED circuit board connects to pin 2 of connector J4 on the CPDA board for the 24VDC power; terminal J2 on the LED circuit board connects to pin 1 of connector J4 on the CPDA board for the ground; and terminal J1 on the LED circuit board connects to pin 6 of connector J4 on the CPDA board for the data line.

The actual 24VDC power and ground to the CPDA board may come from the Optotronic 51512 LED power supply. The load side of the Optotronic 51512 LED power supply contains a screw terminal block with designated connections marked as 24VDC “+” and “−”. The “+” terminal will go to pin 1 on connector J3 of the CPDA board and the “−” terminal will go to pin 2 on connector J3 of the CPDA board. Connector J3 is a Molex/Waldom two-position Mini-fit Jr. connector. The line side of the Optotronic 51512 LED power supply also contains a screw terminal block with designated connections marked as L and N. L represents “Live” or the hot lead of the VAC input and N represents the “neutral” or return lead of the VAC input. The input VAC can range from 108 to 254VAC with nominal input voltages of 120 or 240VAC. AC power input to the IQ38 Spectra Series luminaire can be provided by a line cord for portable applications, from a track adapter for track lighting applications, or from a ballast for HID and fluorescent lamp applications.

A second LED circuit board used in the Altman IQ Spectra Series luminaire, and particularly in the IQ30 series is a complete LED circuit board assembly available from Color Kinetics using the same light source used in its Color Burst 4 (PN: DLE C-102) LED color changing fixtures. The LED circuit board contains seventy-five 5 mm high brightness LEDs. The LED circuit board is rated at 13.2-watts total and functions with just three inputs. The three inputs are power, data, and ground designated as pins 3, 2, and 1, respectively. The power is 24VDC, ground is known as COM, and data is a single wire conductor used to address and control the intensities of each colored LED.

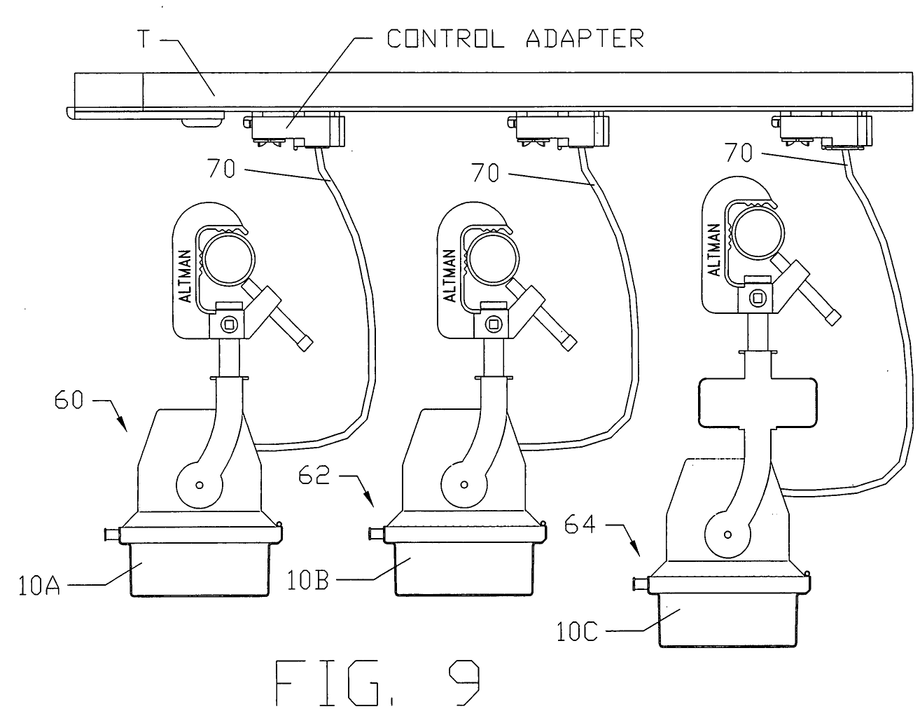

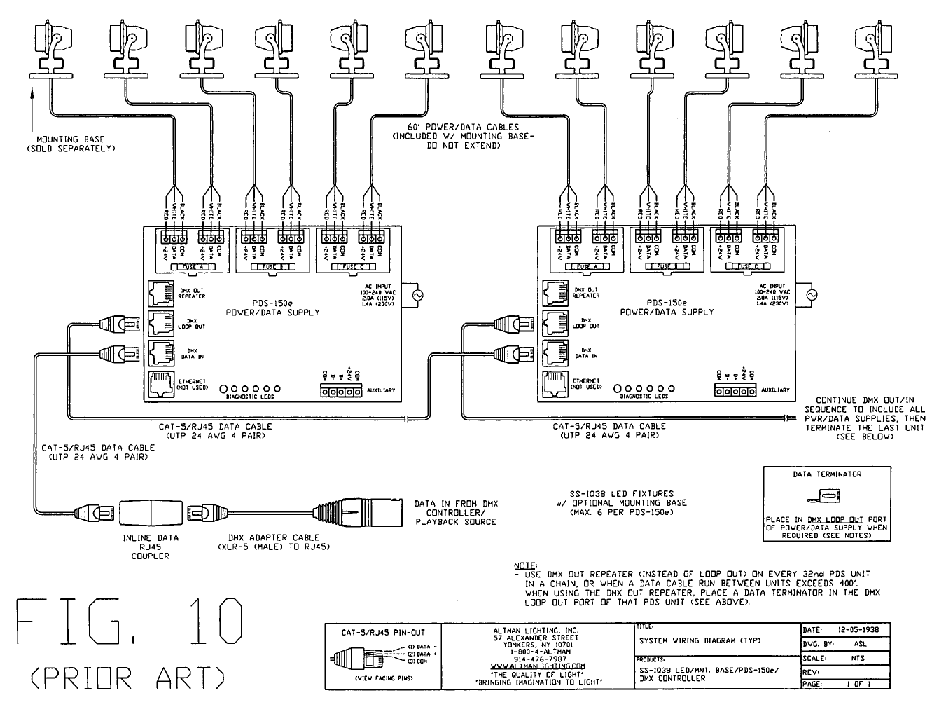

For alternate portable luminaire applications, the power, ground, and data terminals can be brought out to a XLR type connector or similar data connector. An additional pin may be used to connect the luminaire housing to earth ground, but is not a requirement by UL or NEC for low-voltage applications. For a four-pin XLR type connector, pin 1 will be 24VDC power using 14 AWG wire, pin 2 will be earth ground using 22 AWG wire, pin 3 will be data using 22 AWG, and pin 4 will be the common ground or COM for the 24VDC and data line using 14 AWG wire. For a three-pin XLR type connector, pin 1 will be the common ground or COM for the 24VDC and data line, pin 2 will be the 24VDC power, and pin 3 will be the data line. The XLR connectors are available from Neutrik USA, Inc., located in Lakewood, N.J., or an equivalent manufacturer, and the four-conductor cable can be the standard Proplex PCCCT cable available from TMB Inc. in Englewood, N.J., or an equivalent cable supplier meeting the same conductor size requirements, ratings, and safety certifications. In certain instances like permanent installations, no connector is supplied with the luminaire. Instead, the luminaires are supplied with wire pigtails 50 that are hard-wired directly to the input power and control data source, as suggested in FIG. 9.

The seventy-five 5 mm high brightness color LEDs are soldered to one side of a circuit board 20. The opposite side of the circuit board is then affixed to the heat sink 22 adequately designed to dissipate the heat generated by the seventy-five 5 mm high brightness color LEDs. Thermal transfer silicone adhesive type TP190 or Sil-Pads available from Chomerics NA in Woburn, Mass., can be used to affix the circuit board to the heat sink.

The heat sink 22 (FIGS. 3, 4) used is typically one cut from a length of aluminum extrusion. It is available from Aavid Thermalloy Part Number 609753B02276 [VIS # 060975]. This heat sink is preferably black anodized and has a thermal resistance of 4.43° C. per waft. The height of the heat sink is 0.678 in., and the outer dimensions are roughly 2.276 in.×2.276 in. A thermal rule of thumb for heat sink design is to have the heat dissipation surface area at approximately 6 sq. in. for each LED. This heat sink is ideally matched for the LED circuit board used in the IQ30 Spectra Series luminaire. The use of a supplemental cooling fan is optional.

Referring to FIGS. 1 and 2, the LED circuit board 20 and heat sink assembly 22 mounts into the front portion of the rear PAR30 spun-metal housing 12 and is held in place by a circular tension spring clip or other securing bracket means. In the IQ30 Spectra Series luminaire, the LED circuit board and heat sink assembly can be installed and removed easily from the front portion of the rear PAR30 spun metal housing.

A front 3.725 in. diameter diffusion lens 24 installed within the internal accessory holder is used to better mix the color beam outputs from each red, green, and blue LED. It is a ⅛ in. thick plastic lens with a diffused surface on one side of the flat lens and a smooth surface on the opposite side of the flat lens. It is available from Lee Filters USA in Burbank, Calif., or AIN Plastics PN: P95, and has a transmission rating of 90% or better.

The next electrical component in this intelligent LED color changing luminaire is a compact power and data adapter (CPDA) board 26—PN: 20-009952 available from James Industries and manufactured exclusively for Color Kinetics of Boston, Mass. The CPDA board is a double-sided board approximately 2.265 in.×1.875 in. in dimension. There are two Ethernet type RJ45 connectors designated as J1 and J2, which are the inputs and outputs for a DMX control signal. On the RJ45 connectors, pin 1 is DATA−, pin 2 is DATA+, and pin 3 is GROUND for the DMX control signal. The DMX input control signal going into connectors J1 and J2 are subsequently converted within the CPDA board into a single proprietary data control line designated as pin 6 on connector J4. This proprietary data control signal delivers data signals to the LEDs to change color intensities. There is a two-position Molex/Waldom Mini-fit Jr. connector 37 designated as J3 for power input into the CPDA board. Pin 1 of J3 is 24VDC and pin two of J3 is ground or COM. A final six-position Molex/Waldom Mini-fit Jr. connector 38 designated as J4 is used as the power, ground, and data line output to the LED circuit board. Pin 1 is ground or COM out, pin 2 is 24VDC power out, and pin 6 is the data line out to the LED circuit board. Pins 3, 4, and 5 of connector J4 have no designated connections and not used. The RJ45 and Molex/Waldom Mini-Fit Jr. connectors can be replaced with other types of interface connectors, i.e., screw terminal connectors to ease wiring.

Although the CPDA board accepts DMX input control signals, and although they are the preferred control signals in the present invention, other serial data communication protocols can be used in the present invention with conversion hardware to control the intensities of the LEDs. Such serial data communication protocols include, but are not limited to DMX-512, Ethernet, Strand AMX, RS232, RS485, DALI (Digital Addressable Lighting Interface) and analog control signal, among many others.

It should be noted that someone skilled in the arts can substitute other current control techniques and methods to change the intensities of the color LEDs, but it is obvious that the end results arrive at the same if not similar end product disclosed as the preferred embodiment of the present invention and track lighting control system. In addition, in place of color LEDs used in the IQ30 Spectra Series luminaires, monochrome LEDs can be used as the main source of light in the track-mounted LED luminaires of the present invention.

The power supply going into the CPDA board shall be the Optotronic 24VDC LED power supply PN: 51512 available from Osram Sylvania. The Optotronic 51512 LED power supply is a UL and CSA recognized electronic component with Class 2 outputs. It is rated at 20-watts with a nominal universal input voltage range of 120-240 volts AC. The Optotronic 51512 LED power supply has an isolated output so it is protected against open circuits, short circuits, overloads, and overheating. It measures approximately 2.36 in.×2.36 in.×1.20 in. and is protected in a low-profile and weather-resistant plastic housing. The normal operating temperature rating for this power supply is from −20° C. up to 50° C., with a maximum temperature rating of 75° C. This power supply is available from Gilway Technical Lamp Company located in Woburn, Mass. Gilway Technical Lamp Company is the exclusive distributor for Osram Sylvania. It should be noted that someone skilled in the art could use any +24VDC LED power supply.

The CPDA board and the LED power supply mentioned above are also installed inside the IQ PAR30 housing. Standoffs and base plates will hold the CPDA board and LED power supply securely together deep inside the rear portion area of the IQ PAR30 spun-metal housing close to the four ventilation slots.

For alternate portable luminaire applications, the CPDA board and the LED power supply is removed from the luminaire housing. The power, ground, and data lines to the LED circuit board are then brought in from an external source by way of an extension cable. This LED circuit board extension cable will consist of a six-foot 18/3 SVT type or equivalent cord fitted with a mating Molex/Waldom Mini-Fit Jr. six-position vertical dual connector PN: 39-01-2061 fitted with male terminals PN: 44478-3112. This connector will mate with the female Molex/Waldom Mini-Fit Jr. connector attached to other end of the flexible flat ribbon cable that is soldered or attached directly to the LED circuit board by way of input pins 1, 2, and 3. The opposite end of the LED circuit board extension cable is terminated with a Phoenix contact MSTB 2.5/3-ST-5.08 three-position screw terminal plug. This plug can be used directly with a Color Kinetics Power and Data Supply, i.e., PDS-150e, which will allow a customer to connect up to twelve IQ30 luminaires at the same time. The PDS150e provides the 24VDC, ground, and data necessary to control the intensities of each high-brightness 5 mm color LEDs located in the LED circuit board.

The track-lighting fittings and track adapters used in the preferred embodiment of the present invention are the GLOBAL control SELV-data track system available from Nordic Aluminium represented in North America by Kaltek, Inc., located in Atlanta, Ga. The lighting track fittings include 1, 2, and 3 circuit tracks designated by their GC7 series part numbers and their multi-adapter track adapters are available in two and three circuit versions designated by their GC68 series part numbers. A GLOBAL control module designated by part number GCM-DMX is required to bring the DMX control signals from a DMX controller directly to the track-lighting fittings. In the near future, GLOBAL will be introducing a modified power and control data track that will take advantage of both DMX and DALI control data protocols.

Internal wiring of the electronic components of the IQ30 Spectra Series luminaires will consist of the following detailed pin-to-pin descriptions. The LED circuit board contains three terminal mounting solder pad holes. The three holes include power, ground, and data connections. These three holes designated as pins 1, 2, and 3 are tied into the CPDA board to connector J4 by way of a flexible flat ribbon cable with 18 AWG stranded wire. The mating plug to connector J4 is a Molex/Waldom six-position dual-row Mini-fit Jr. connector. Pin 3 on the LED circuit board will connect to pin 2 of connector J4 on the CPDA board for the 24VDC power; pin 1 on the LED circuit board will connect to pin 1 of connector J4 on the CPDA board for the ground; and pin 2 on the LED circuit board will connect to pin 6 of connector J4 on the CPDA board for the data line.

The actual 24VDC power and ground to the CPDA board will come from the Optotronic 51512 LED power supply. The load side of the Optotronic 51512 LED power supply contains a screw terminal block with designated connections marked as 24VDC “+” and “−”. The “+” terminal will go to pin 1 on connector J3 of the CPDA board and the “−” terminal will go to pin 2 on connector J3 of the CPDA board. Connector J3 is a Molex/Waldom two-position Mini-fit Jr. connector. The line side of the Optotronic 51512 LED power supply also contains a screw terminal block with designated connections marked as L and N. L represents “Live” or the hot lead of the VAC input and N represents the “Neutral” or return lead of the VAC input. The input VAC can range from 108 to 254VAC with nominal input voltages of 120 or 240VAC. AC power input to the IQ30 Spectra Series luminaire can be provided by a line cord for portable applications, from a track adapter for track lighting applications, or from a ballast for HID and fluorescent lamp applications.

The preferred embodiment for this application will be an IQ Spectra Series luminaire mounted to a special DMX track adapter. The three DMX control signals from the Nordic Aluminium GLOBAL Trac Control lighting track fitting will feed into the Global Trac Control multi-adapter GC68. The GC68 contains three push-in terminals for each of the three corresponding DMX signals, i.e. DATA− to “−” on the GC68, DATA+ to “+” on the GC68, and GROUND to G on the GC68. The GC68 also contains three screw terminals for AC voltage connections from the lighting track, i.e., live to L on the GC68, neutral to N on the GC68, and ground to the center pin designated with the EARTH GROUND symbol on the GC68. As with any electrical connections, wire of an appropriate gauge to handle the current and voltage as required by NEC is to be used at all times. FIGS. 7 and 9 show the complete assembly of an IQ Spectra Series LED color-changing luminaire with all the internal components installed and located.

GLOBAL control is used as a part of data-controlled lighting to carry the control signal. The GLOBAL control system allows control of individual light fittings or groups of fittings. This kind of lighting is particularly suitable for special exhibitions—in museums, for example—where varying kinds of ambience are created with lighting. The GLOBAL control data track is based on the GLOBAL pro system. Three control wires have been added to the three-circuit track. The control wires transfer the data signal from a control console or other controller to the fitting. The conductors in the GC68 adapter transmit the signal from the track to the fixture. The fitting requires an integrated converter card to enable it to receive the signal from a controller. The converter card reads and recognizes the signal leading to the desired function.

At present, no other track lighting manufacturer offers a similar track fitting that incorporates the line voltage track with a low voltage control signal data on the same fitting. Nordic Aluminium owns UK Patent Application No. GB231 0326A, “A track conductor assembly with control signal bus,” which relates to their GLOBAL control power and data system.

The combination of power and data on the same track fitting offers the end-user various advantages. The main advantage is LED color-changing track-mounted luminaries 60 can now be used with conventional track-mounted luminaries 62, 64 that use high-voltage incandescent, halogen, compact fluorescent, and HID type lamps (FIGS. 7, 9), all operating on the same line voltage lighting track. The scalable GLOBAL control power and data system provides ease of use and operating flexibility. With the use of three-circuit track, color-changing LED luminaires like the Altman IQ Spectra Series luminaires can be used on one circuit; incandescent or halogen lamp based luminaires can be used on a second circuit; and compact fluorescent or HID lamp based luminaires can be used on a third circuit. Dimming of the LED luminaires are achieved through the DMX control signal, as will be well know to those skilled in the art; dimming of incandescent or halogen lamp based luminaires are achieved by standard SCR or other types of wall dimmers; and dimming of compact fluorescent or HID lamp based luminaires can be achieved with the use of DMX controlled mechanical dimmers.

Other DMX controllable modules like gel-medium color changers, gobo rotators, conventional DMX controlled intelligent moving light luminaires, etc., can now all be used simultaneously on the same GLOBAL power and data control track light fitting without the need to run additional cables and wires that can become unsightly and cumbersome to install and dress. Overall system cost and installation time is reduced using this system.

Altman Lighting presently owns two U.S. patents relating to a DMX or similarly controlled Digital Micromirror Device (DMD) or Digital Light Projector (DLP) moving luminaire—U.S. Pat. No. 6,671,005, “Digital micromirror stage lighting system,” and U.S. Pat. No. 6,412,972, “Digital light protection apparatus with digital micromirror device and rotatable housing.” This computer-controlled DMD/DLP moving luminaire can be used in the Nordic Aluminium GLOBAL Control Track taking AC power from the track and digital control communications data from the track as well. A separate video and/or audio signal interface, i.e., X10 video sender and receiver modules can be used to provide video and/or audio signals from a remote source directly to the DMD/DLP moving luminaire by way of RF or IR carrier means.

DMX control signals are provided by DMX control boards, Personal Data Assistant's (PDAs), or other DMX controllers. With the advancement in wireless control technology, DMX signals can now be transmitted either by IR (infrared) or RF (radio-frequency) conversion devices from a transmitter to a receiver without having to deal with cumbersome cables or wiring. City Theatrical Inc., located in the Bronx, N.Y., offers a DMX-512 WDS Wireless Dimming System, and Goddard Design Company located in Brooklyn, N.Y., offers a DMX-WOW (WithOut Wires) system. Both companies, among many others, offer wireless transmission of DMX control signal products that can easily be incorporated into the present LED color-changing luminaire and track lighting system invention. FIG. 10 shows a typical wiring diagram and layout for a similar Color Kinetics Color Burst 6 system devoid of a lighting track.

An alternate track lighting system embodiment and hanging configuration can be used for applications where standard lighting track and adapters manufactured by Halo, Juno, Lightolier, etc., can be used to power the IQ Spectra Series luminaires with a separate DMX or other digital serial communication control signal pigtail or receptacle exiting from the luminaire housing. Returning to FIG. 9, in applications where Unistrut metal framing 72 is used, a heavy weighted luminaire can be installed in the Unistrut metal framing. The DMX or other digital serial communication can be obtained from a convenience adapter that extracts the DMX control data signal off the GLOBAL Control Track T to a pigtail 70 or receptacle mounted on a breakout box secured to the Nordic Aluminium GLOBAL Control Track adapter.

In the alternate track lighting system embodiment, the IQ Spectra Series track-mounted LED luminaires will have both the CPDA and the LED power supply installed in the IQ fixture housing as before, but the DMX or other data control signal lines serving as inputs to the CPDA will now be brought out externally by way of a receptacle or pigtail to a remote DMX receiver. This remote DMX receiver will receive a DMX signal from a DMX console or other transmitter and then forward the digital control signal to each IQ Spectra Series Luminaire. This flexibility allows a customer to use the existing track but still offer the color-changing capability and overall look of the Altman IQ Spectra Series luminaires, and can be used with other class of luminaires in their present layout.

Although the present invention has been described in some detail by way of illustration and example for purposes of clarity and understanding, it will, of course, be understood that various changes and modifications may be made in the form, details, and arrangements of the parts without departing from the scope of the invention set forth in the following claims.

1. A LED luminaire track lighting system comprising:
an elongate track suitable for attachment to a support surface, said track including a plurality of longitudinal guideways;
a plurality of current conductors arranged in at least some of said longitudinal guideways, at least a first number of conductors being power conductors and a second number of conductors being data conductors, said conductors being electrically isolated from each other;
adapter means connected to a source of power for applying electrical power to said power conductors and connected to a source of control data for applying power to said data conductors;
at least one LED color changing luminaire including a plurality of LEDs, each generating one of a discrete plurality of colors when energized;
data converter means for converting data on said data lines to control currents for each individual group of color LEDs to create a desired composite color; and
connecting means for at least electrically connecting at least one LED color-changing luminaire to said power conductors and data conductors within said track.
